(19) United States
(12) Patent Application Publication
(10) Pub. No.: US 2025/0037085 A1
(43) Pub. Date: Jan. 30, 2025

(54) SHIFT GENERATION SYSTEM, SHIFT GENERATION METHOD, AND NON-TRANSITORY RECORDING MEDIUM STORING COMPUTER-READABLE SHIFT GENERATION PROGRAM

(71) Applicant: KONICA MINOLTA, INC., Tokyo (JP)

(72) Inventor: Tatsuya NAKANO, Sagamihara-shi (JP)

(21) Appl. No.: 18/743,870

(22) Filed: Jun. 14, 2024

(30) Foreign Application Priority Data
Jul. 27, 2023 (JP) 2023-122136

(51) Int. Cl. G06Q 10/1057; G06Q 10/0631

(52) U.S. Cl. CPC G06Q 10/1057; G06Q 10/06311

(57) ABSTRACT

A shift generation system that generates a work shift for a plurality of staff members of a facility, the shift generation system including: a hardware processor that sets a shift condition, acquires information regarding the staff members, and generates the work shift based on the shift condition and the information regarding the staff members, in which the hardware processor generates and sets the shift condition based on a selected condition for acquiring an additional reward.

### CROSS-REFERENCE TO RELATED APPLICATION

Japanese patent application No. 2023-122136 filed on Jul. 27, 2023, including description, claims, drawings, and abstract the entire disclosure is incorporated herein by reference in its entirety.

### BACKGROUND OF THE INVENTION

### 1. Technical Field

The present invention relates to a shift generation system, a shift generation method, and a non-transitory recording medium storing a computer-readable shift generation program.

### 2. Description of Related Art

In a care facility, it is possible to obtain not only a basic reward from a user or care insurance, but also an additional reward related to a care reward from the Ministry of Health, Labor, and Welfare by arranging the system of a facility. On the other hand, when a basic system as a facility becomes insufficient, there is a possibility that the facility becomes a target of subtraction for repaying a part of the reward. It is very important for the care facility to obtain a reward for addition, and furthermore, by satisfying the requirement for addition, the system of the facility is completed, and the quality of a service provided to the user is also improved. Therefore, when a shift for staff members is examined, whether or not a reward for addition can be obtained is considered.

In an organization such as a nursing care facility or a company that performs shift work, time and psychological burdens on a person in charge of shift generation are large, and therefore, introduction of shift generation software which automatically generates a shift table is expanding.

On the other hand, in the shift generation software, there is a problem that setting a shift condition (shift generation rule) necessary for shift generation is complex. In particular, in a care facility or the like, ICT is not advanced so much, and a person in charge who is not accustomed to an operation of a computer terminal cannot set a shift generation condition and needs to inquire a support, which takes time.

Japanese Unexamined Patent Application Publication No. 2021-89540 discloses the following related technique. The operation support system for a welfare facility includes a registration status checking section, service providing hours/full-time working hours checking section, an absent service provision staff member subtraction checking section, an additional staff member addition checking section, and an excess staff member subtraction checking section. In addition, the system includes an error content display part which displays error content related to a work schedule based on a result of checking by each of these parts. The registration status checking section checks registration information of each staff member based on staff member information and shift information. The service providing hours/full-time working hours checking section checks setting information regarding service providing hours and the number of hours for which a full-time worker should work, based on business hours setting information. The absent service provision staff member subtraction checking section checks subtraction due to an absent service provision staff member based on a work schedule of each staff member calculated based on staff member information, work schedule information, and shift information, and setting information checked by the checking of the number of service providing hours and full-time working hours. The additional staff member addition checking section checks addition due to an additional staff member based on a calculated scheduled time to work for each staff member and setting information checked by the checking of the number of service providing hours and full-time working hours. The excess staff member subtraction checking section checks subtraction due to an excess staff member based on use application information of the facility and system information or the like reported to a local government. Then, based on these checking results, error content related to the work schedule is displayed. Accordingly, it is possible to easily check whether or not a work schedule satisfies a requirement for calculation of a reward unit price.

### SUMMARY OF THE INVENTION

However, the above-described conventional technology can check whether an already generated shift satisfies a requirement for addition. On the other hand, the above-described conventional technology cannot solve the complexity of setting a shift condition for generating a shift that satisfies the requirement for addition.

The present invention has been made in consideration of the above-described circumstances. That is, an object of the present invention is to provide a shift generation system, a shift generation method, and a non-transitory recording medium storing a computer-readable shift generation program that can eliminate complexity of setting a shift condition for generating a shift that satisfies a requirement for addition.

To achieve at least one of the abovementioned objects, according to an aspect of the present invention, a system one aspect of the present inventions comprises the followings.

(1) A shift generation system that generates a work shift for a plurality of staff members of a facility, the shift generation system including: a hardware processor that sets a shift condition, acquires information regarding the staff members, and generates a work shift based on the shift condition and the information regarding the staff members, wherein the hardware processor generates and sets the shift condition based on a selected condition for acquiring an additional reward.

To achieve at least one of the abovementioned objects, according to an aspect of the present invention, a method one aspect of the present inventions comprises the followings.

A shift generation method executed by a shift generation system that generates a work shift for a plurality of staff members of a facility, the shift generation method including: (a) setting a shift condition; (b) acquiring information regarding the staff members; and (c) generating the work shift based on the shift condition and the information regarding the staff members, wherein in (a), the shift condition is generated and set based on a selected condition for acquiring an additional reward.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating a schematic configuration of an entire system;

FIG. 2 is a block diagram illustrating a schematic configuration of an information processing terminal;

FIG. 3 is a diagram illustrating an example of a facility information acceptance screen;

FIG. 4 is a diagram illustrating an example of another facility information acceptance screen;

FIG. 5 is a diagram illustrating an example of a shift condition acceptance screen;

FIG. 6 is a diagram illustrating an example of another shift condition acceptance screen;

FIG. 7 is a block diagram illustrating a schematic configuration of a server;

FIG. 8 is a block diagram illustrating functions of a CPU;

FIG. 9 is an explanatory diagram illustrating a generated shift;

FIG. 10 is a flowchart illustrating an operation of the system; and

FIG. 11 is a flowchart illustrating an operation of the system.

### DETAILED DESCRIPTION

Hereinafter, one or more embodiments of the present invention will be described with reference to the drawings. However, the scope of the invention is not limited to the disclosed embodiments.

In the following, embodiments of the present invention will be described with reference to the accompanying drawings. Note that in the description of the drawings, the same components are denoted by the same reference signs, and redundant descriptions are omitted. In addition, dimensional ratios in the drawings are exaggerated for convenience of description and may be different from actual ratios.

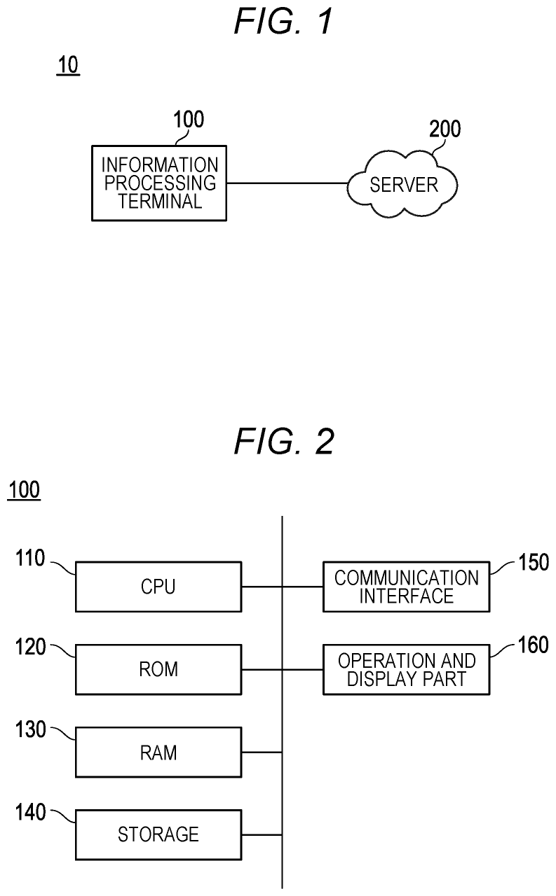

FIG. 1 is a diagram illustrating a schematic configuration of an entire system 10 according to an embodiment of the present invention.

As illustrated in FIG. 1, the system 10 includes an information processing terminal 100 and a server 200. The information processing terminal 100 and the server 200 are configured to be connectable to each other via a network. The server 200 is, for example, a cloud server, but may be an on-premise server (server device) or the like. The server 200 forms a shift generation system. The server 200 and the information processing terminal 100 may form a shift generation system.

The system 10 may be installed inside a facility, and some or all of the constituent elements may be installed outside the facility (e.g., a headquarters house of a corporation that operates a plurality of facilities).

In order to simplify the description, a case where the facility is a nursing care facility and a work shift (hereinafter, simply referred to as a “shift”) for a plurality of staff members who work in the facility is generated will be described below as an example.

### <Information Processing Terminal 100>

The information processing terminal 100 is, for example, a terminal used by a user such as a facility manager, a manager, or an administrator of the care facility, and is a desktop PC, a notebook PC, a tablet PC, a smartphone, or the like.

FIG. 2 is a block diagram illustrating a schematic configuration of the information processing terminal 100.

As illustrated in FIG. 2, the information processing terminal 100 includes a central processing unit (CPU) 110, a read only memory (ROM) 120, a random access memory (RAM) 130, a storage 140, a communication interface 150, and an operation and display part 160. The respective components are communicably connected to each other via a bus.

The CPU 110 performs control of the above-described components and various kinds of arithmetic processing in accordance with programs recorded in the ROM 120 and the storage 140.

The ROM 120 stores therein various programs or various kinds of data.

The RAM 130, as a workspace, temporarily stores therein a program and data.

The storage 140 is provided with a hard disc drive (HDD), a solid state drive (SDD), or the like, and stores various programs including an operating system and various kinds of data. For example, an application for accepting input (including an instruction and the like) from the user, transmitting and receiving various kinds of information to and from other devices such as the server 200, and outputting (displaying) information regarding the operation and display part 160 is installed in the storage 140.

The communication interface 150 is an interface for communicating with other apparatuses. As the communication interface 150, a communication interface based on various wired or wireless standards is used.

The operation and display part 160 is, for example, a touch screen type display, displays various kinds of information, and accepts various kinds of input from the user.

The CPU 110 accepts information regarding the facility and information regarding the staff members input by the user on the operation and display part 160. The CPU 110 may cause the storage 140 to store the information regarding the facility and the information regarding the staff members. The information regarding the facility includes, for example, the number of residents and an additional reward to be acquired (hereinafter, also simply referred to as “addition”). The information regarding the staff members includes, for example, information regarding the staff members, which is used to generate the shift, such as the number of staff members, acquired qualifications, occupation types, and work forms. The staff members include full-time and part-time care staff members, nursing staff members, nutritionists, and the like.

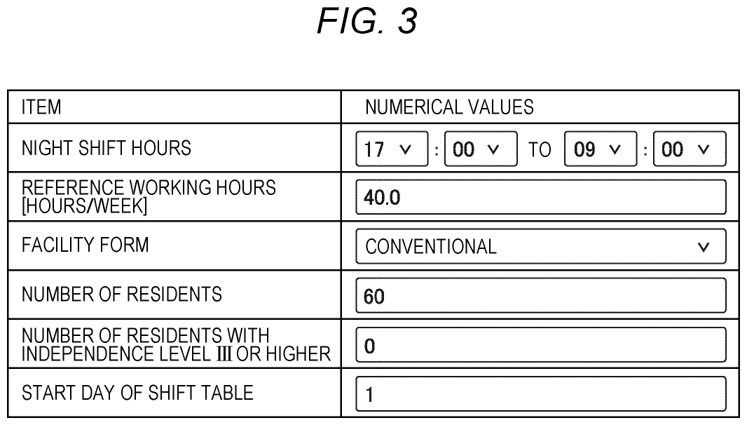

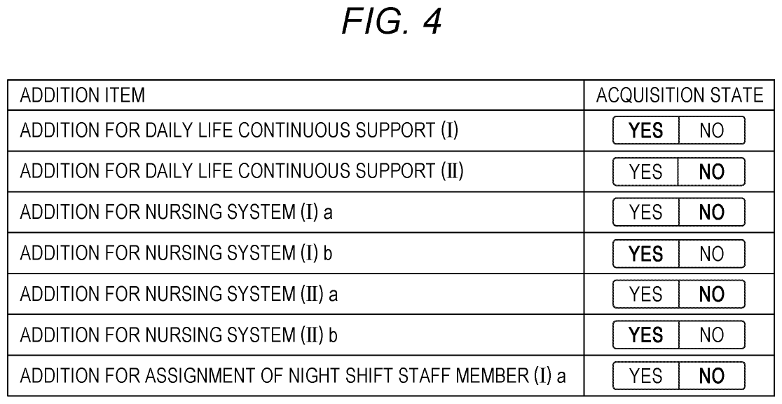

FIG. 3 is a diagram illustrating an example of a facility information acceptance screen. The facility information acceptance screen is displayed on the operation and display part 160. The CPU 110 accepts the information regarding the facility input to the facility information acceptance screen. The information accepted on the acceptance screen illustrated in FIG. 3 is transmitted to and registered in the server 200 (the same applies to information accepted on acceptance screens illustrated in FIGS. 4 to 6).

In the example illustrated in FIG. 3, as the information regarding the facility, the number of residents, night shift hours (night shift time zone), reference working hours, the facility form, and the like are input to the facility information acceptance screen.

FIG. 4 is a diagram illustrating an example of another facility information acceptance screen.

In the example illustrated in FIG. 4, as the information regarding the facility, addition to be acquired is input to the facility information acceptance screen by selection of a button. Addition for which a “yes” button is selected is the addition to be acquired. In FIG. 4, letters of selected buttons are indicated in bold. On the facility information acceptance screen, as the addition to be acquired, addition for daily life continuous support (I), addition for a nursing system (I) b, and addition for a nursing system (II) b are selected. The addition to be acquired may be addition currently acquired by the facility or addition to be acquired by the facility. The addition to be acquired may be addition recommended to be acquired from the server 200, as described later. Addition suggested to be acquired from the server 200 may be displayed as a default by selecting a button in advance on the facility information acceptance screen. Thus, the user can grasp the addition suggested to be acquired from the server 200.

The CPU 110 can accept a shift condition input by the user on the operation and display part 160. The shift condition is a condition that needs to be satisfied by a shift to be generated, and is a rule for generating the shift. As described later, the shift condition is generated and set by the server 200 based on a condition (also referred to as an “addition requirement”) for acquiring addition to be acquired. The CPU 110 accepts a shift condition not generated by the server 200 as input from the user on the operation and display part 160. The acquisition conditions for each addition are registered in advance in a later-described addition condition table in the server 200.

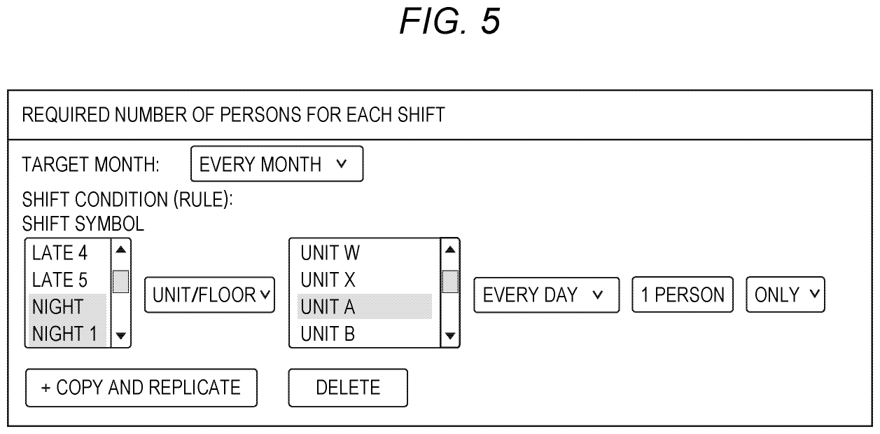

FIG. 5 is a diagram illustrating an example of a shift condition acceptance screen. The shift condition acceptance screen is displayed on the operation and display part 160. The CPU 110 accepts a shift condition input by the user on the shift condition acceptance screen.

In the example illustrated in FIG. 5, a required number of persons for each shift symbol (a required number of persons for each shift) is input as a shift condition on the shift condition acceptance screen. That is, assigning shift symbols “night” and “night 1” to one of staff members belonging to a unit “unit A” every day every month is input as a shift condition.

Each shift symbol is a unique symbol corresponding to a combination of work hours and a work time period.

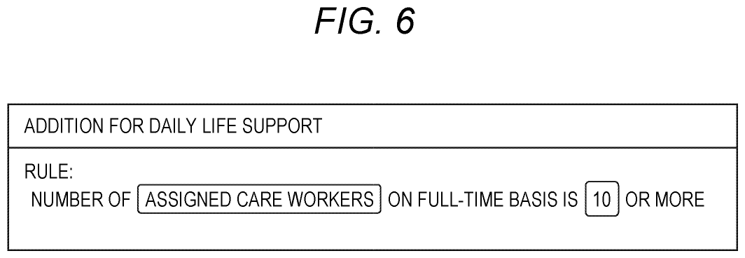

FIG. 6 is a diagram illustrating an example of another shift condition acceptance screen.

In the example illustrated in FIG. 6, a shift condition generated by the server 200 is displayed by default on the shift condition acceptance screen. That is, as the shift condition generated by the server 200, “the number of assigned care workers on a full-time basis is 10 or more” is displayed by default. The shift condition is a shift condition generated by the server 200 based on a condition for acquiring “addition for daily life support”. Thus, the user can check the shift condition generated by the server 200. The user can appropriately modify the default-displayed shift condition on the acceptance screen.

The CPU 110 transmits, to the server 200, the shift condition input by the user on the operation and display part 160 and the shift condition modified by the user.

### <Server 200>

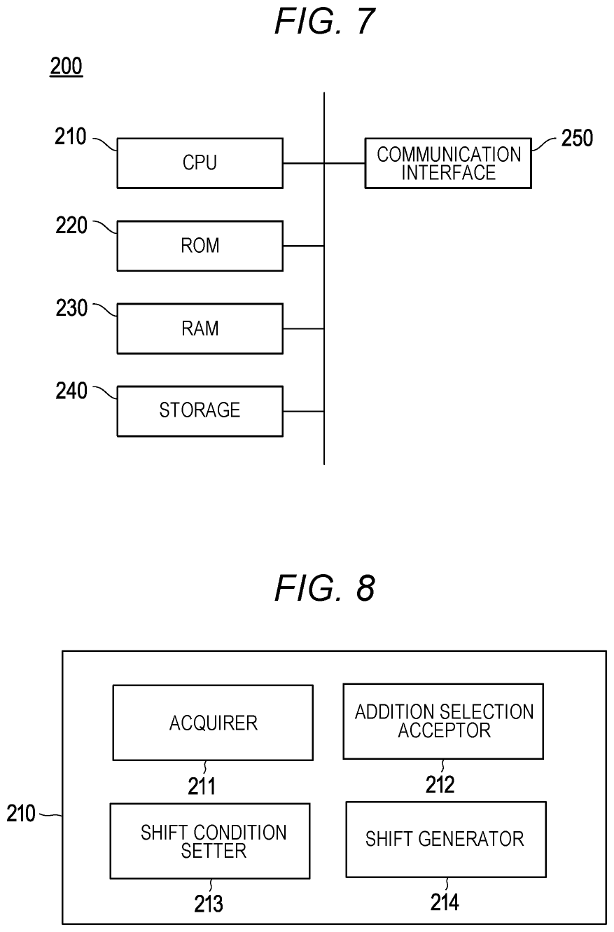

FIG. 7 is a block diagram illustrating a schematic configuration of the server 200.

As illustrated in FIG. 7, the server 200 includes a CPU 210, a ROM 220, a RAM 230, a storage 240, and a communication interface 250. The components are communicably connected to each other via a network or a bus. The CPU 210 forms a hardware processor.

Since configurations and basic functions of the CPU 210, the ROM 220, the RAM 230, the storage 240, and the communication interface 250 are similar to those of the respective corresponding elements of the information processing terminal 100, redundant description is omitted. Specific functions of CPU 210 will be described later.

In the storage 240, a program for the CPU 210 to perform each process is installed. The storage 240 also stores the information regarding the staff members, the information regarding the facility, and the shift condition received from the information processing terminal 100 or the like. The shift condition includes, for example, the condition that “the number of consecutive days available for work, including a night shift day, is 2 days”, the condition that “the number of consecutive days available for work, excluding a night shift day, is 5 days”, and the condition that “working hours of a full-time staff member per week is 40 hours”. The shift condition may include a condition that is applied only to a predetermined staff member. An example of the condition applied only to the predetermined staff member includes “not work at night” for a staff member such as a dispatched person who has a contract not to work at night. In addition, an example of the condition applied only to the predetermined staff member includes “not work for three or more days a week” for a part-time staff member who has a contract of working for two days a week.

The shift condition includes a condition that depends on the addition to be acquired. For example, the condition for acquiring the “addition for daily life support” is that “the number of assigned full-time care workers for six users is one or more”. Therefore, for example, in a case where the number of residents of the facility is 60, it is necessary to set a shift satisfying the shift condition that “the number of assigned care workers on a full-time basis is 10 (60 persons÷6=10 persons) or more”.

FIG. 8 is a block diagram illustrating functions of the CPU 210. The CPU 210 operates in accordance with a program to function as an acquirer 211, an addition selection acceptor 212, a shift condition setter 213, and a shift generator 214. The shift condition setter 213 constitutes a setter. The shift generator 214 constitutes a generator.

The acquirer 211 acquires the information regarding the staff members. Specifically, the acquirer 211 can acquire the information regarding the staff members input by the user on the operation and display part 160 of the information processing terminal 100 by receiving the information regarding the staff members from the information processing terminal 100. The acquirer 211 may acquire the information regarding the staff members received from the information processing terminal 100 and stored in the storage 240 by reading the information regarding the staff members from the storage 240.

The acquirer 211 may further acquire the information regarding the facility. Specifically, the acquirer 211 can acquire the information regarding the facility input by the user on the operation and display part 160 of the information processing terminal 100 by receiving the information regarding the facility from the information processing terminal 100. The acquirer 211 may acquire the information regarding the facility received from the information processing terminal 100 and stored in the storage 240 by reading the information regarding the facility from the storage 240.

The information regarding the staff members and the information regarding the facility may be acquired by the acquirer 211 by being input to software for executing the functions illustrated in FIG. 7. On the other hand, the acquirer 211 may acquire, from other software than the above-described software, the information regarding the staff members and the information regarding the facility that have been input to the other software.

The addition selection acceptor 212 accepts selection (input) of addition to be acquired. Specifically, the addition selection acceptor 212 can accept the addition selected by the user on the operation and display part 160 of the information processing terminal 100 by receiving the selected addition from the information processing terminal 100. The addition selected on the operation and display part 160 is also simply referred to as “selected addition”. The addition selection acceptor 212 may acquire the selected addition received from the information processing terminal 100 and stored in the storage 240 by reading the selected addition from the storage 240.

The addition selection acceptor 212 may include addition recommended to be acquired in the selected addition. The addition selection acceptor 212 can determine the addition recommended to be acquired as follows. The addition selection acceptor 212 collates the information regarding the facility and a condition for acquiring each addition, and calculates the degree of satisfaction of the condition for acquiring each addition. The addition selection acceptor 212 determines, as the addition recommended to be acquired, addition for which the degree of satisfaction of the acquisition condition is equal to or more than a predetermined threshold.

The shift condition setter 213 generates and sets a shift condition based on the selected condition for acquiring the addition. For example, a condition for acquiring “addition for the nursing care system (I)” is that “one or more full-time nurses are assigned” or the like. The shift condition setter 213 can generate and set a shift condition such as the condition that “one or more full-time care workers are assigned” by calculation based on the acquisition condition. The addition condition table in which addition names are associated with condition for acquiring addition may be stored in the storage 240 in advance. The shift condition setter 213 can specify the selected condition for acquiring the addition by using the addition condition table.

The shift condition setter 213 may generate and set a shift condition based on the selected condition for acquiring the addition and the information regarding the facility. For example, as described above, the condition for acquiring the “addition for daily life support” is that “the number of assigned full-time care workers for six users is one or more”. The shift condition setter 213 generates and sets a shift condition that “the number of assigned care workers on a full-time basis is 10 or more” by calculation based on the acquisition condition and the number of residents included in the information regarding the facility. Depending on a condition for acquiring addition, the shift condition setter 213 can generate and set, as a shift condition, at least one of the number of staff members and the number of qualified persons required to satisfy the condition for acquiring the addition, based on the condition for acquiring the addition and the number of residents.

The shift condition setter 213 may transmit the generated shift condition to the information processing terminal 100 to display the shift condition on the shift condition acceptance screen (refer to FIG. 6) on the operation and display part 160 of the information processing terminal 100. In this case, a checking button may be displayed on the shift condition acceptance screen, and a shift condition may be set after approval for the shift condition is obtained through selection of the checking button by the user. The shift condition setter 213 may receive, from the information processing terminal 100, a shift condition modified by the user on the shift condition acceptance screen, and set the received shift condition. On the other hand, the shift condition setter 213 may set a shift condition as soon as the shift condition is generated, without transmitting the generated shift condition to the information processing terminal 100.

The shift generator 214 generates a shift based on a shift condition set by the shift condition setter 213 and the acquired information regarding the staff members. The shift generator 214 can use a genetic algorithm to generate a shift that satisfies a set shift condition.

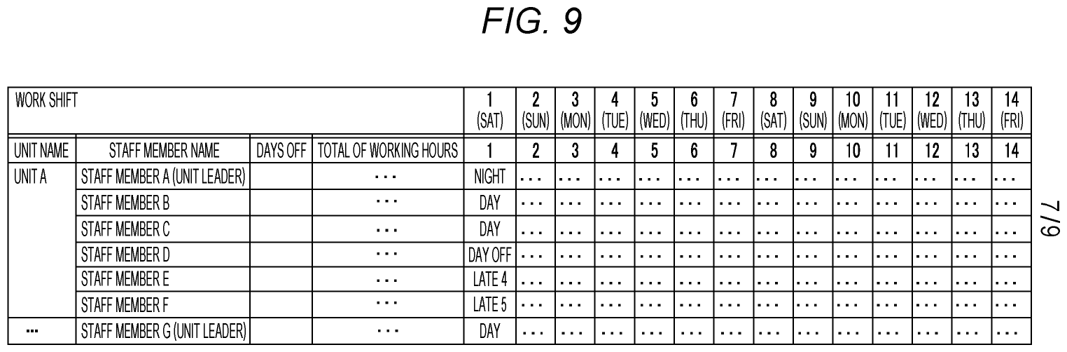

FIG. 9 is an explanatory diagram illustrating the generated shift.

As illustrated in FIG. 9, the shift is a shift in which a shift symbol is assigned to each staff member on a daily basis. Note that most of the shift symbols are not illustrated in FIG. 9.

The shift generator 214 outputs the generated shift. The output includes transmission to the information processing terminal 100 or the like by the communication interface 250. The output includes display on the operation and display part 160 or the like of the information processing terminal 100, printout from an image forming apparatus, and the like.

Operation of the system 10 will be described.

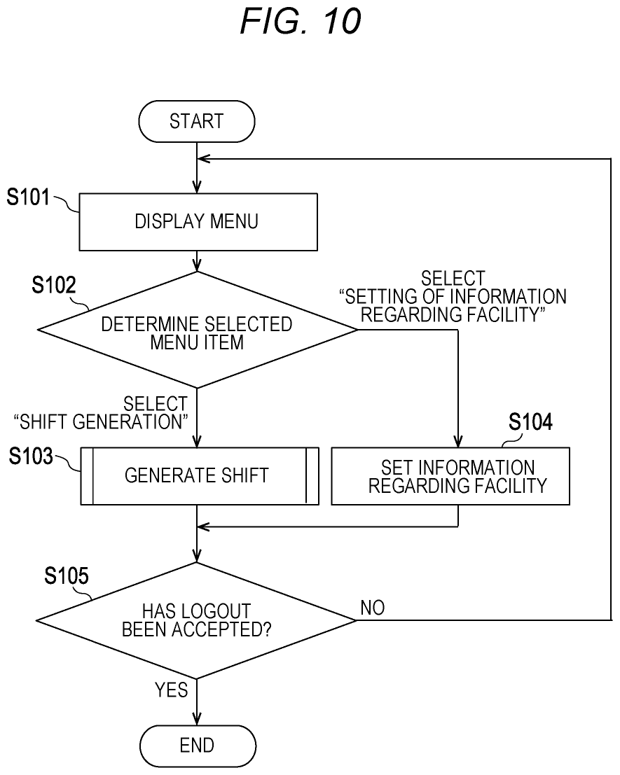

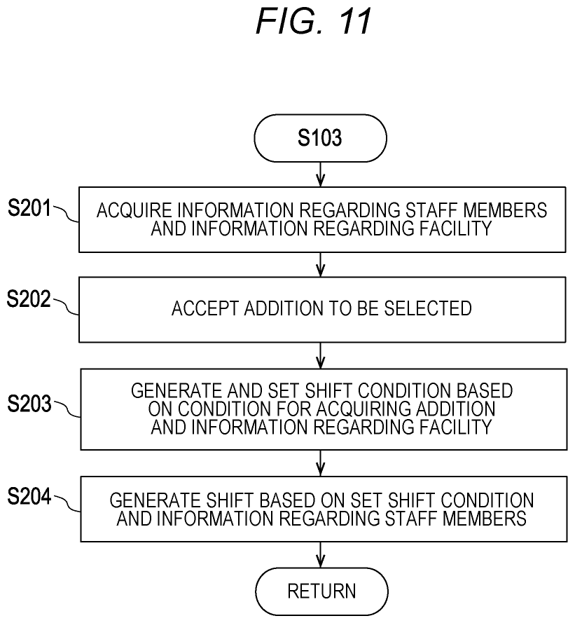

FIGS. 10 and 11 are flowcharts illustrating operations of the system 10. Processing illustrated in this flowchart can be performed by the CPU 210 controlling each part according to a program stored in the storage 240 of the server 200.

The CPU 210 transmits a menu screen to the information processing terminal 100 and causes the information processing terminal 100 to display the menu screen, thereby causing the information processing terminal 100 to display a menu (S101).

The CPU 210 determines a menu item selected by the user from among menu items displayed on the information processing terminal 100 (S102). To be more specific, the CPU 210 determines the selected menu item by receiving information regarding the selected menu item from the information processing terminal 100.

In a case where the CPU 210 determines that a menu item of “shift generation” has been selected, the CPU 210 generates a shift (S103). In a case where the CPU 210 determines that a menu item of “setting of information regarding the facility” has been selected, the CPU 210 displays a facility information acceptance screen (e.g., the acceptance screen illustrated in FIG. 3) in the information processing terminal 100. Next, the CPU 210 receives, from the information processing terminal 100, the information regarding the facility input by the user on the acceptance screen, and sets the information regarding the facility (S104).

The CPU 210 determines whether the information processing terminal 100 has accepted logout (S105). In a case where the CPU 210 determines that the logout has not been accepted, the CPU 210 performs steps S101 to S105. In a case where the CPU 210 determines that the logout has been accepted, the CPU 210 ends the process.

FIG. 11 is a subroutine flowchart of step S103 illustrated in FIG. 10.

The CPU 210 acquires the information regarding the staff members and the information regarding the facility by receiving the information regarding the staff members and the information regarding the facility from the information processing terminal 100 (S201). The CPU 210 may acquire the information regarding the staff members and the information regarding the facility stored in the storage 240 by reading the information regarding the staff members and the information regarding the facility from the storage 240.

The CPU 210 accepts addition to be selected (S202). The CPU 210 accepts the addition selected by the user in the information processing terminal 100 by receiving the addition from the information processing terminal 100. The CPU 210 may determine addition recommended to be acquired and accept the determined addition as the addition to be selected.

Based on the condition for acquiring the addition and the information regarding the facility, CPU 210 generates and sets a shift condition (S203). Depending on the addition, the CPU 210 can generate a shift condition based on only the condition for acquiring the addition.

The shift generator CPU 210 generates a shift based on the set shift condition and the information regarding the staff members, and outputs the shift (S204). In this case, CPU 210 may specify and output a shift condition that is not satisfied by the information regarding the current staff members or the like. The CPU 210 can accept a slight modification of the shift from the user who has checked the generated shift, modify the shift, and output the modified shift. As the slight modification, for example, it is considered that a staff member who works in a day shift is shifted to a night shift in order to satisfy the shift condition. In addition, as the slight modification, it is considered that the shift is modified in response to a staff member's desire for vacation that is not included in the shift condition.

The embodiments produce the following effects.

A shift condition is generated and set based on a selected condition for acquiring an additional reward, and a work shift is generated based on the shift condition and the acquired information regarding the staff members. Thus, the complexity of setting the shift condition for generating the shift that satisfies the addition requirement can be eliminated.

Further, the information regarding the facility is acquired, and a shift condition is generated and set based on the condition for acquiring the additional reward and the information regarding the facility. Thus, even for the shift condition that requires the information regarding the facility, the complexity of setting the shift condition for generating a shift that satisfies the addition requirement can be eliminated.

Furthermore, the information regarding the facility includes the number of residents of the facility. Based on the number of residents,
the number of staff members and/or the number of qualified persons required to satisfy the condition for acquiring the additional reward is generated and set as the shift condition. Thus, for the shift condition that requires information regarding the number of residents, it is also possible to eliminate the complexity of setting the shift condition on the number of staff members and/or the number of qualified persons for generation of a shift that satisfies the addition requirement.

In addition, the information regarding the staff members and the information regarding the facility are acquired by being input to software executed in the shift generation system. Alternatively, the information regarding the staff members and the information regarding the facility, which have been input to other software than the software, are acquired from the other software. It is possible to eliminate complexity of inputting the same information for each of a plurality of pieces of software.

The present invention is not limited to the above-described embodiments, and various modifications can be made within the scope of the claims.

For example, each of the information processing terminal 100 and the server 200 may include constituent elements other than the above-described constituent elements, or may not include some of the above-described constituent elements.

In addition, the information processing terminal 100 and the server 200 may be separate apparatuses or may be a single apparatus.

Further, the function of each component may be implemented by another component. For example, at least a part of the processing described as being performed on the server 200 may be performed by the information processing terminal 100 or another apparatus. Alternatively, the information processing terminal 100 may be omitted by providing the server 200 with the functions of the information processing terminal 100.

Also, the processing units of the flowcharts in the above embodiments are divided according to the main processing contents in order to facilitate understanding of each processing. The present invention is not limited by the way of dividing the processing steps. Each processing may be divided into more processing steps. One processing step may execute additional processing. Also, multiple steps may be performed concurrently or in combination.

Means and methods for performing the various kinds of processing in the system according to the above-described embodiment can be implemented by any of a dedicated hardware circuit and a programmed computer. The computer-readable program may be provided, for example, by a non-transitory recording medium such as a flexible disk or a CD-ROM, or may be provided online via a network such as the Internet. In this case, the computer-readable program recorded on the non-transitory recording medium is usually transferred to and stored in a storage such as a hard disk. Furthermore, the program may be provided as independent application software, or may be incorporated in software of the apparatus as one function of the system.

Although embodiments of the present invention have been described and illustrated in detail, the disclosed embodiments are made for purpose of illustration and example only and not limitation. The scope of the present invention should be interpreted by terms of the appended claims.

What is claimed is:

1. A shift generation system that generates a work shift for a plurality of staff members of a facility, the shift generation system comprising:
a hardware processor that sets a shift condition, acquires information regarding the staff members, and generates the work shift based on the shift condition and the information regarding the staff members, wherein
the hardware processor generates and sets the shift condition based on a selected condition for acquiring an additional reward.

2. The shift generation system according to claim 1, wherein the hardware processor acquires information regarding the facility, and generates and sets the shift condition based on the condition for acquiring the additional reward and the information regarding the facility.

3. The shift generation system according to claim 2, wherein
the information regarding the facility includes the number of residents of the facility, and
the hardware processor generates and sets, as the shift condition, at least one of the number of staff members and the number of qualified persons required to satisfy the condition for acquiring the additional reward based on the number of residents.

4. The shift generation system according to claim 2, wherein the information regarding the staff members and the information regarding the facility are acquired by the hardware processor by being input to software executed in the shift generation system, or the hardware processor acquires the information regarding the staff members and the information regarding the facility which input to other software than the software from the other software.

5. A shift generation method executed by a shift generation system that generates a work shift for a plurality of staff members of a facility, the shift generation method comprising:
(a) setting a shift condition;
(b) acquiring information regarding the staff members; and
(c) generating the work shift based on the shift condition and the information regarding the staff members, wherein
in (a), the shift condition is generated and set based on a selected condition for acquiring an additional reward.

6. The shift generation method according to claim 5, wherein
in (b), information regarding the facility is acquired, and
in (a), the shift condition is generated and set based on the condition for acquiring the additional reward and the information regarding the facility.

7. The shift generation method according to claim 6, wherein
the information regarding the facility includes the number of residents of the facility, and
in (a), at least one of the number of staff members and the number of qualified persons required to satisfy the condition for acquiring the additional reward is generated and set as the shift condition based on the number of residents.

8. The shift generation method according to claim 6, wherein
in (b), the information regarding the staff members and the information regarding the facility that have been input to the shift generation system are acquired, or the information regarding the staff members and the information regarding the facility that have been input to another system other than the shift generation system are acquired from the other system.

9. A non-transitory recording medium storing a computer-readable shift generation program for causing a computer to execute the shift generation method according to claim 5.
